(19) United States
(12) Patent Application Publication
(10) Pub. No.: US 2026/0225554 A1
(43) Pub. Date: Aug. 6, 2026

(54) AN AIR-BAG

(71) Applicant: AUTOLIV DEVELOPMENT AB, Vargarda (SE)

(72) Inventors: Malgorzata WASILEWSKA, Lubsza (PL); Mateusz KEDZIERSKI, Czerwieñsk (PL); Irena MUSIAL, Olawa (PL)

(21) Appl. No.: 19/159,147

(22) PCT Filed: Mar. 21, 2024
(86) PCT No.: PCT/EP2024/057658

§ 371 Date: Aug. 22, 2025

(30) Foreign Application Priority Data
Mar. 23, 2023 (DE) 10 2023 107 393.1

(51) Int. Cl. B60R 21/231

(52) U.S. Cl. CPC B60R 21/231

(57) ABSTRACT

An air-bag, comprising opposing first and second side panels, which are joined together at a main seam, wherein: a first lateral seam-meets the main seam and extends away therefrom, terminating at a free end, wherein the first lateral seam is formed from opposing edges formed in the first side panel, which are joined to each other.

This application relates to an air-bag, and in particular concerns a vehicle air-bag which can be inflated to lift the arm of a user during an impact.

Inflatable air-bags have been used in vehicles for many years. Modern vehicles include several air-bags which are located at various positions within the vehicle to protect occupants of the vehicle, and also others such as pedestrians and cyclists with whom the vehicle might collide, in the event of an accident.

One such air-bag may be positioned within the side of a vehicle seat, and arranged to inflate in the event of a side impact. The air-bag is adapted to inflate in the space between the occupant's torso and the interior of the side of the vehicle, to provide protection to the occupant's torso during the impact.

During deployment of an air-bag of this type, the occupant's arm can sometimes be positioned between the air-bag and the occupant's torso. This can cause problems because the air-bag is sized and configured to bear against the side of the occupant's torso. In addition, injuries to the occupant's ribs, arm and shoulder may arise if the occupant's arm is trapped in this position.

To reduce the risk of these problems occurring, an air-bag of this type may be configured so that, as it inflates, the occupant's arm is lifted upwardly, into a position above the air-bag. The air-bag can then act to protect the occupant's torso in the correct manner during the impact itself.

An example of a known type of this air-bag can be seen, for example, in U.S. Pat. No. 10,640,074. This document discloses an air-bag which is formed from two main side panels, which are attached to each other around their perimeters.

A further design of an air-bag of this kind is shown in U.S. Pat. No. 8,322,747. This document discloses an air-bag which is formed from side panels, but in addition to this a separate top panel is included, which is sewn in place between upper edges of the side panels. The presence of the top panel gives the resulting air-bag a wider, flatter top surface when it is inflated. However, this air-bag is more costly and time-consuming to manufacture.

It is an object of the invention to provide an improved air-bag of this type.

Accordingly, one aspect of the invention provides an air-bag as set out in claim 1.

Preferred features of the invention are set out in the dependent claims.

In order that the invention may be more readily understood, embodiments thereof will now be described, by way of example only, with reference to the accompanying drawings, in which:

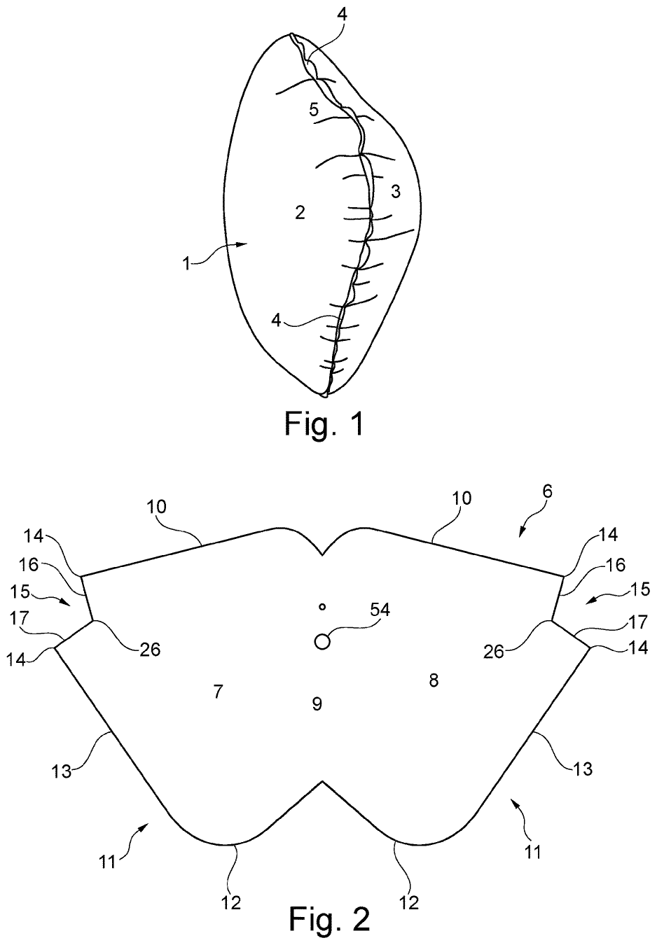

FIG. 1 shows a known type of air-bag;

FIG. 2 shows a first blank suitable for forming an air-bag embodying the present invention;

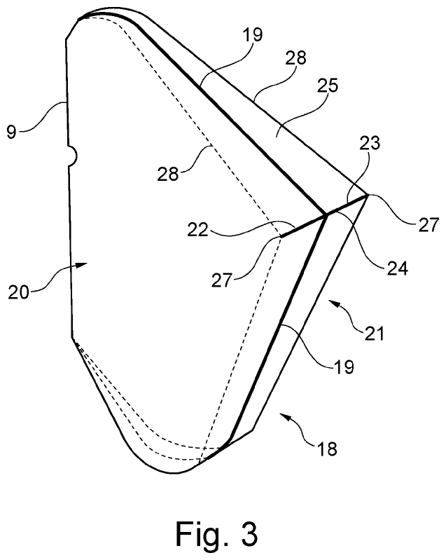

FIG. 3 is a schematic view of an air-bag formed from the first blank shown in FIG. 2;

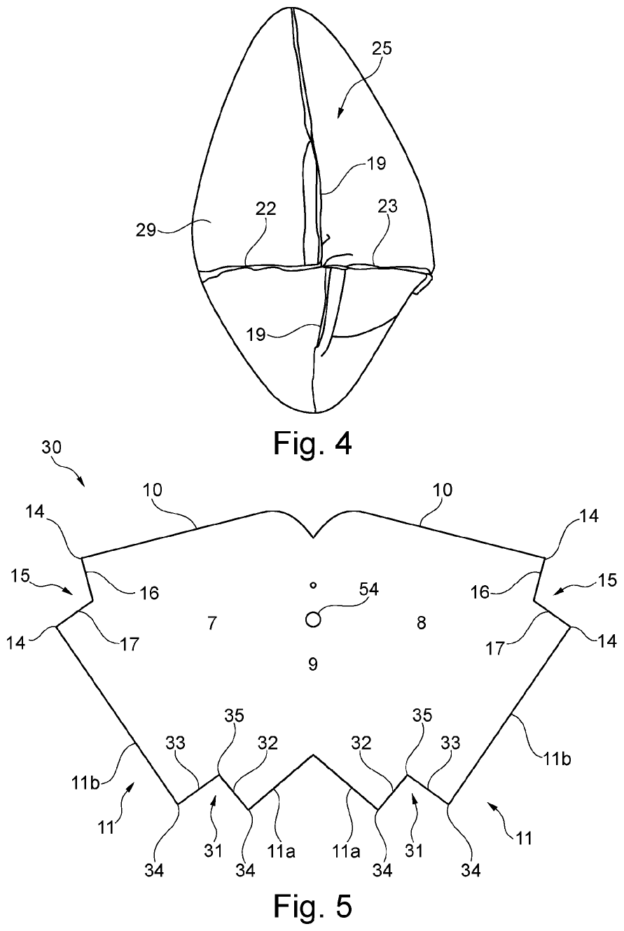

FIG. 4 shows an air-bag formed in accordance with FIGS. 2 and 3;

FIG. 5 shows a second blank suitable for forming an air-bag embodying the present invention;

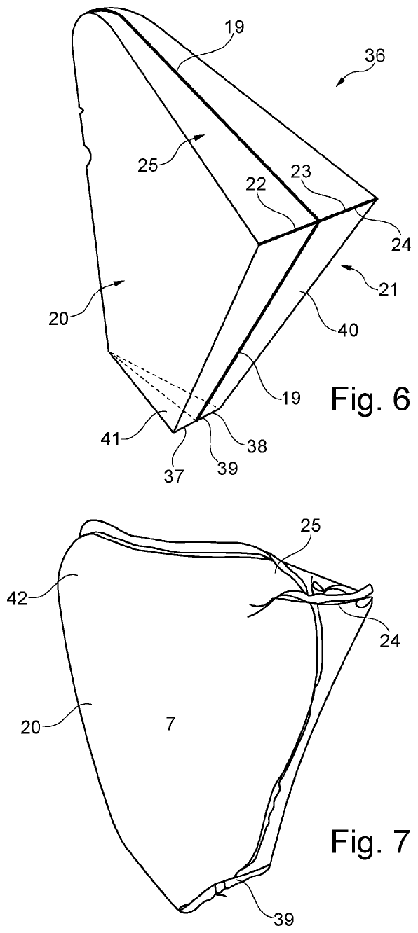

FIG. 6 is a schematic view of an air-bag formed from the second blank shown in FIG. 5;

FIG. 7 shows an air-bag formed in accordance with FIGS. 5 and 6; and

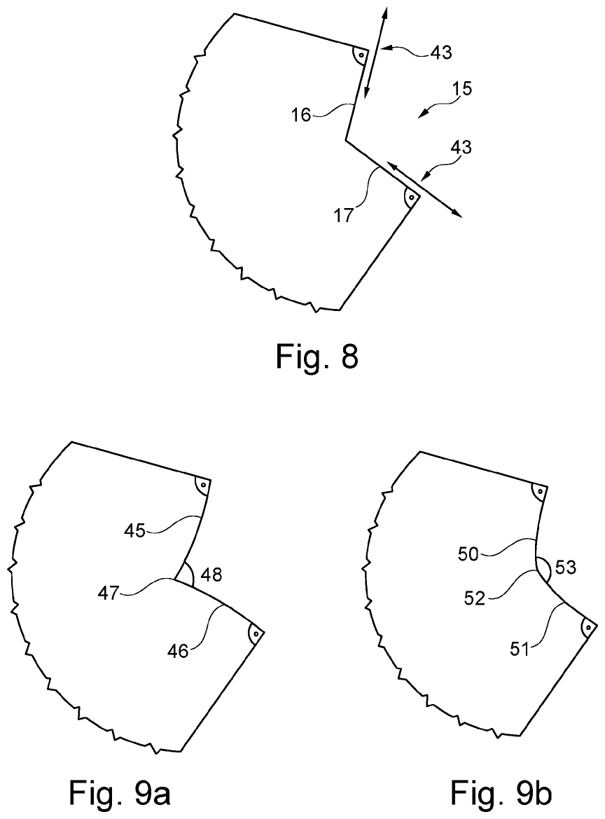

FIGS. 8, 9a and 9b illustrate ways in which aspects of blanks suitable for forming air-bags in accordance with the invention may be varied.

With reference firstly to FIG. 1, this figure shows a known side air-bag 1, which is configured to lift a seat occupant's arm. The air-bag 1 includes first and second side panels 2, 3, which are generally triangular in shape, and which are joined at their edges by a main seam 4. As the air-bag 1 inflates, a top surface 5 thereof engages the underside of the seat occupant's arm, to drive the arm upwardly.

The air-bag 1 would typically be manufactured from a “blank” which is a unitary region of fabric, and which includes both the first and second side panels 2, 3. Before the blank is formed into the air-bag 1, the first and second side panels 2, 3 are integrally joined together at a connecting region which, when the air-bag 1 is assembled, lies on a back side of the air-bag 1, i.e. the edge which is furthest away in the view shown in FIG. 1. To form the air-bag 1, the unitary region of fabric is folded at the connecting region, so that the first and second side panels 2, 3 overlie each other. The edges of the first and second side panels 2, 3 are then joined together by sewing, to form the main seam 4.

Before being folded, the unitary blank resembles a butterfly, and the type of air-bag 1 shown in FIG. 1 is sometimes known as a butterfly air-bag.

Turning to FIG. 2, a first blank 6 that can be used to form an air-bag embodying the invention is shown.

The first blank 6 is preferably formed from a unitary region of fabric, which is formed in a continuous and unbroken manner. In preferred embodiments, the first blank 6 is formed from woven fabric, and in such an embodiment all or substantially all of the first blank 6 may be formed in a single weaving operation.

The first blank 6 may be formed, for example, by cutting the first blank 6 from a sheet of woven material that is produced continuously by a weaving loom.

While forming the first blank 6 from a unitary region of fabric is preferred with regard to simplicity and reliability, this is not essential. In other embodiments the first blank 6 may be formed from two or more regions of fabric or material which are formed and subsequently joined together, for instance by sewing.

In the example shown in FIG. 2, the first blank 6 includes first and second side regions 7, 8.

When the first blank 6 is formed into an air-bag, the first and second side regions 7, 8 will respectively form first and second side panels of the air-bag.

The first blank 6 further comprises a connecting region 9, which is between the first and second side regions 7, 8.

In preferred embodiments, the first blank 6 is symmetrical or substantially symmetrical around a central line, which in the view shown in FIG. 2 is vertical and passes through the connecting region 9. It is not essential for the first blank 6 to be symmetrical, however.

Each of the first and second side regions 7, 8 extends away from the connecting region 9. Each of the first and second side regions 7, 8 has a top edge 10. In the example shown in FIG. 2, each top edge 10 is generally straight over the majority of its length. This is not essential, however, and the top edge 10 of each side region 7, 8 may take any suitable form.

The first and second side regions 7, 8 also each comprise a bottom edge 11. In the example shown in FIG. 2, a first region 12 of each bottom edge 11 extends away from the connection region 9 and describes a curved or arced shape. A second region 13, which is further from the connection region 9 and is contiguous with the first region 12, is generally straight over the majority of its length.

Once again, this shape for the bottom edges 11 is not essential, and the bottom edges 11 my take any suitable form.

As can be seen in FIG. 2, the overall shape of the first blank 6 approximately resembles that of a butterfly.

Each top edge 10 and bottom edge 11 terminates at a termination point 14 which is furthest from the connection region 9. The termination point 14 of each top edge 10 is spaced apart from the termination point 14 of the corresponding bottom edge 11.

A notch 15 is formed between the termination points 14 of each top edge 10 and the corresponding bottom edge 11. In the example shown in FIG. 2, each notch 15 comprises first and second edges 16, 17 (which in the example shown are edges of the region of fabric from which the first blank 6 is formed). The first edge 16 meets the termination point 14 of the top edge 10. The second edge 17 meets the termination point 14 of the bottom edge 11. The first and second edges 16,17 meet each other at a meeting point 26, at their points furthest from the respective termination points 14. In this embodiment the first and second edges are substantially straight. In the example shown in FIG. 2, the first and second edges 16, 17 form an angle at the meeting point 26.

To form the first blank 6 into an air-bag, the top edges 10 of the first and second side regions 7, 8 are joined to each other. The bottom edges 11 of the first and second side regions 7, 8 are also joined to each other.

At the notch 15 of each side region 7, 8, the first edge 16 is joined to the second edge 17. As can be appreciated from FIG. 2, when the first and second edges 16, 17 of each notch 15 are joined together, the termination points 14 of the top and bottom edges 10, 11 on that side of the first blank 6 will be drawn together so that they meet.

FIG. 3 is a schematic view of a first air-bag 18 embodying the invention, which is formed from the first blank 6 shown in FIG. 2. As can be seen in FIG. 3, where the top edges 10 and bottom edges 11 of the two side regions 6, 7 are joined together, this forms a main seam 19 which extends continuously around the regions of the first air-bag 18 that are not joined together at the connection region 9.

The first air-bag 18 has first and second side panels 20, 21, which are primarily formed from the first and second side regions 7, 8 respectively.

Where the first and second edges 16, 17 of the notch 15 of the first side region 7 are joined together, this forms a first lateral seam 22, which extends away from the main seam 19. In the arrangement shown in FIG. 3, the first lateral seam 22 is generally perpendicular to the main seam 19.

Similarly, where the first and second edges 16, 17 of the notch 15 of the second side region 8 are joined together, this forms a second lateral seam 23, which once again extends away from the main seam 19, and may be substantially at right angles thereto.

The first and second lateral seams 22, 23 meet each other to form a combined lateral seam 24, which extends across the main seam 19, and extends on both sides thereof. In preferred embodiments the first and second lateral seams 22, 23 are generally aligned, so that the combined lateral seam 24 is straight or substantially straight where it extends across the main seam 19.

The first air-bag 18 has a top surface 25 which, in use, will face generally upwards when the first air-bag 18 is inflated. The top surface 25 extends on either side of the portion of the main seam 19 which arises from joining of the top edges 10 of the first and second side regions 7, 8.

As can be seen in FIG. 3, the top surface 25 of the first air-bag 18 is relatively flat, compared to the top side of the known air-bag 1 shown in FIG. 1. The skilled reader will appreciate that this configuration arises from the combined lateral seam 24, which extends laterally from the main seam 19 in both directions, and hence provides additional width to the top surface 25. There is preferably an identifiable change in the angle of the air-bag surface at a side edge 28, which is at a perimeter of the top surface 25, in contrast to the known air-bag 1 shown in FIG. 1, which has a more elliptical shape.

In particular, a generally triangular region of the first air-bag 18, which extends from the point at which the main seam 19 meets the connection region 9, and extending on both sides of the main seam 19 to the free ends 27 of the first and second lateral seams 22, 23, will have a generally flat configuration.

The skilled reader will understand that, since the air-bag 18 is formed from fabric, and in use will be inflated to a high pressure, the top surface 25 will not be completely flat, and side edges 28 of the top surface 25 will not represent a sharp angle between the top surface 25 and the generally laterally-facing main regions of the first and second side panels 20, 21. However, the top surface 25 will provide an identifiable region which is generally flat in configuration.

The skilled reader will appreciate that the provision of the first and second lateral seams 22, 23 allows the shape of the top surface 25 of the first air-bag 18 to have a shape which is considerably flatter than that of an air-bag of the type shown in FIG. 1. This will mean that the first air-bag 18 can lift the arm of an occupant in a more reliable manner. The relatively flat top surface 25 of the first air-bag 18 will be able to engage the underside of the occupant's arm over a greater surface area, and push the arm upwards effectively.

The provision of the first and second lateral seams 22, 23 will also increase the width of the top part of the first air-bag 18. This can be seen by comparing the first air-bag 18 with the known air-bag 1 shown in FIG. 1, in which a middle region of the air-bag 1 has greatest width, and the width of the top part of the air-bag 1 is less than the width of the middle region.

This will provide further benefits in cushioning the parts of the occupant's torso against which the top region of the first air-bag 18 engaged during an impact.

FIG. 4 shows an image of an air-bag 29 formed in accordance with the embodiment which is described above and shown in FIGS. 2 and 3.

FIG. 5 shows a second blank 30. Many of the features of the second blank 30 are the same as those of the first blank 6, including the presence of first and second side regions 7, 8, a connection region 9 which joins the first and second side regions 7, 8 to each other, the top edges 10 of the first and second side regions 7, 8, and the notch 15 formed on each side region 7, 8.

However, in the second blank 30, each of the first and second side regions 7, 8 also has a second notch 31. In the example shown in FIG. 5 the second notch 31 is formed part way along the bottom edge 11 of each side region 7, 8.

Similarly to the first notch 15, each second notch 31 has a first edge 32 and a second edge 33. In the embodiment shown in FIG. 5 the first and second edges 32, 33 are each substantially straight. In the example shown in FIG. 5, the bottom edge 11 of each of the first and second side regions 7, 8 has a first portion 11a, which extends away from the connection region 9 and terminates at a termination point 34, where it meets the first edge 32 of the corresponding second notch 31.

Within each second notch 31, the first edge 32 meets the second edge 33 at a meeting point 35, similar to the first notches 15.

The second edge 33 of each second notch 31 ends at a termination point 34, where it meets a second portion 11b of the bottom edge 11. In this embodiment the second portion 11b extends to the termination point 14, described above in relation to FIG. 2, where it meets the second edge 17 of the first notch 15.

To convert the second blank 30 into an air-bag, the first and second edges 16, 17 of each first notch 15 are joined to each other, and the first and second edges 32, 33 of each second notch 31 are also joined to each other. The top edges 10, and first and second portions 11a, 11b of the bottom edge 11, of the first and second side regions 7,8 are also joined to each other.

A schematic view of the resulting second air-bag 36 is shown in FIG. 6.

The second airbag 36 has many features in common with the first airbag 18, including the combined lateral seam 24 which arises from the first notches 15.

However, in addition, there is a further first lateral seam 37, which is formed from the first and second edges 32, 33 of the second notch 31 of the first side region 7 from being joined to each other. The second airbag 36 also comprises a further second lateral seam 38 which arises from the joining of the first and second edges 32, 33 of the second notch 31 of the second side region 8 to each other.

Each of these further lateral seams 37, 38 extends away from the main seam 19, and may extend away therefrom right angles or substantially right angles. As before, the further first and second lateral seams 37, 38 combine, in the embodiment shown in FIG. 6, to form a combined further lateral seam 39, which crosses the main seam 19 and extends away therefrom in both directions. The further first and second lateral seams 37, 38 may be aligned or substantially aligned with each other so that, where they cross the main seam 19 they combined to form a substantially straight seam. This is not essential, however.

In the embodiment shown in FIG. 6, and also in the second airbag 18 shown in FIG. 3, the combined lateral seam 24 is at or substantially at a junction between the top surface 25 of the airbag 18, 36, and a front surface 40 of the airbag 18, 36. The front surface 40 faces generally away from the connection region 9 when the airbag 18, 36 is assembled and inflated, and when installed in a vehicle and inflated the front surface 40 will face generally in the direction of forward travel of the vehicle.

In the arrangement shown in FIG. 6, the combined further lateral seam 39 is at or substantially at a junction between the front surface 40 and a bottom surface 41 of the airbag 36. When the second airbag 36 is assembled and inflated, the bottom surface 41 will face in a direction that is generally opposite the direction in which the top surface 25 faces. The bottom surface 41 may extend between the front surface 40 and the connection region 9. When the second airbag 36 is installed in a vehicle and inflated, the bottom surface 41 faces generally downwards towards the floor of the vehicle.

FIG. 7 shows an airbag 42 which is constructed in accordance with the embodiment described above in connection with FIGS. 5 and 6. As can be seen in FIG. 7, the airbag 42 has increased width in its lower region, compared to both the first airbag 18 shown in FIG. 3 and the known airbag 1 shown in FIG. 1. This increased width in the lower region of the airbag 42 arises from the further lateral seam 39.

Once again, this will increase the overall thickness/depth of the airbag, in the direction between the first and second side panels 20, 21, which will provide extra protection and cushioning to a seat occupant during a side impact.

It will also be understood that the bottom surface 41 of the airbag 42 has a greater degree of flatness than the bottom surface of either the first airbag 18 shown in FIG. 5 of the known airbag 1 shown in FIG. 1. For similar reasons described above in relation to the flatness of the top surface 25, the flatness of the bottom surface 41 arises from the provision of the further lateral seam 39.

The presence of the further lateral seam 39 allows greater control over the shape and thickness of the bottom part of the air-bag 42. The dimensions of the inflated air-bag 42 can be controlled to fit more closely and/or effectively against the body of a seat occupant or against a part of the vehicle, or to provide protection and cushioning of a desired level.

In addition to the examples described above, other embodiments of the invention may include a lower lateral seam, in a position corresponding to that of the further lateral seam 39, without also including any further lateral seam.

In generally, it is preferred to provide lateral seams where the surface of the airbag turns through an angle. Embodiments of the invention may include an upper lateral seam, corresponding to the combined lateral seam 24 shown in FIGS. 4 and 6, at or approximately at the junction between the top surface of the airbag and the front surface of the airbag. Examples may also include a lower lateral seam, corresponding in position to the further combined lateral seam 39 shown in FIG. 6, which is positioned at or approximately at the junction between the front surface of the airbag and the bottom surface of the airbag.

In examples of the invention an airbag may be provided with only the top lateral seam (as shown in FIG. 4), only the bottom lateral seam (i.e. without an upper lateral seam also being present), or with both an upper and a lower lateral seam (as shown in FIG. 6).

The depth/thickness of the airbag can be controlled by selecting an appropriate length for the first and second edges of a lateral seam. This is indicated in FIG. 8, where a first notch 15 is shown, arrows 43 indicate that the length of the first and second edges 16, 17 may be increased or decreased to control the length of the resulting lateral seam. The longer the first and second edges 16, 17 are, the longer the resulting lateral seam will be.

With reference to FIG. 2, a first distance may be defined as the horizontal distance from a centre line, which passes vertically through the connection region 9, to the meeting point 26 of the first and second edges 16, 17 of one of the notches 15 (here the terms horizontal and vertical are used as in the orientation of FIG. 2).

It is anticipated that the maximum length for a lateral seam may be in the region of 50% of the first distance. Conversely, providing a lateral seam having a length below around 20 mm is unlikely to change the shape of the airbag in a significant manner, compared to the shape of the known butterfly airbag 1 shown in FIG. 1.

It is preferred that, for any notch formed as described herein, the first and second edges are of the same length.

In preferred embodiments, for a combined lateral seam which extends away from the main seam in both directions, it is preferred that the first lateral seam and second lateral seam are of the same or substantially the same length. This will maintain a generally symmetrical shape for the airbag, and also confers benefits with regard to simplicity, as the blank which forms the airbag can also be generally symmetrical.

However, this need not be the case. In other embodiments, first and second lateral seams which meet to form a combined lateral seam can be of different lengths. This may allow greater control over the shape of the air-bag, which may be useful in certain applications. For instance, with reference to the air-bag shown in FIG. 3, the airbag may be configured to be positioned in the exterior side of the seat which is positioned on the left of the vehicle, when viewed in the forward direction of travel. This seat will be the driver's seat in a territories where vehicles drive on the right, and the passenger seat in territories where vehicles drive on the left. When this air-bag is inflated within a vehicle, the first side panel 20 will face towards the torso of the seat occupant, and the second side panel 21 will face towards the interior side of the vehicle.

In such an example, it may be preferred for the first lateral seam 22 to have a relatively long length, which will lead to a relatively large thickness on the corresponding side of the airbag 18 which may conform more closely to the shape of the seat occupant's torso. Conversely, the second lateral seam 23 may be relatively short, leading to a relatively flat shape on the corresponding side of the airbag, which will match more closely the shape of the interior side of the vehicle.

An air-bag embodying the invention may also act as a “pre-push” air-bag, which acts to push the seat occupant away from the side of the vehicle as it is inflated. This places additional distance between the seat occupant and the side of the vehicle, which will reduce the likelihood of injury if the side of the vehicle is involved in an impact. For such an air-bag, it is envisaged that the lateral seam on the side of the air-bag that is closest to the seat occupant may be longer than the lateral seam on the side of the air-bag that is closest to the interior side of the vehicle. This will give the air-bag a shape to push the occupant away from the interior side of the vehicle in an effective manner.

The skilled reader will appreciate how the lengths of the first and second lateral seams which meet to form a combined lateral seam may differ to control the shape of the resulting airbag in any desired way.

It is also envisaged that, in some embodiments, there may be a lateral seam on one side of the main seam, but no corresponding lateral seam on the other side of the main seam. Such embodiments may be used in circumstances where it is desired for one side of the air-bag to have an increased depth/thickness, but the other side does not require increased depth/thickness and can have a shape which is similar to the shape of one side of the known air-bag 1 shown in FIG. 1.

As described above, a top part of the main seam 19, that is formed by joining the top edges 10 of the first and second side regions 7, 8, extends along the top surface 25 of the air-bag, and meets the lateral seam(s). A front part of the main seam 19, that is formed by joining the bottom edges 11 of the first and second side regions 7, 8, extends along the front surface 40 of the air-bag and meets the lateral seam(s).

In some embodiments, the air-bag may be formed such that the point at which the top part of the main seam 19 meets the lateral seam(s) is offset from the point at which the front part of the main seam 19 meets the lateral seam(s). This offset is preferably in the lateral direction, i.e. a direction which is generally perpendicular to the direction of the main seam 19.

An offset of this kind can be seen in FIG. 4, in which the top part of the main seam 19 meets the first lateral seam 22 at a point which is further to the left (in the orientation of this figure) than the point at which the front part of the main seam 19 meets the second lateral seam 23,

This offset can be advantageous because, if the top and front parts of the main seam 19 meet the lateral seam(s) at the same point, a large number of seams may meet at a single junction point, which will require a large amount of reinforcement (e.g. by sewing). This single junction point may be a likely point of failure during inflation of the air-bag. However, by having an offset as described above, the forces that arise during inflation may be more distributed, and a single likely point of failure is avoided.

In the embodiments described above, first and second edges of each notch are straight or substantially straight. However, this need not be the case. In the example shown in FIG. 9a, a notch has first and second edges 45, 46, which are each curved so that, as the first and second edges 45, 46 meet each other at a meeting point 47, they subtend an internal angle 48 which is less than 90°.

Conversely, with reference to FIG. 9b, a further notch has first and second edges 50, 51 which are curved so that, when they meet at a meeting point 52, they subtend an internal angle 53 which is greater than 90°.

Indeed, the first and second edges of a notch may be generally curved in a continuous manner such that there is no distinct meeting point at which the first and second edges form a sharp angle.

The skilled reader will appreciate that changing the shape of the first and second edges in this way will allow greater control over the shape of the resulting airbag. For example, with reference again to the airbag shown in FIG. 3, if the first and second lateral seams 22, 23 were formed using notches as shown in FIG. 9a, these seams would curve towards the rear region of the airbag 18 (i.e. towards the connection region 9) as they extend away from the main seam 19. This configuration of the seams also leads to reduced stress on the seams during inflation of the air-bag, as the forces resulting from inflation are more distributed along the length of the lateral seams.

Conversely, if these first and second lateral seams 22, 23 were formed from notches formed in accordance with FIG. 9b, these seams would curve forwardly, away from the rear region of the airbag (i.e. away from the connection region 9) as they extend away from the main seam 19.

The skilled reader will therefore appreciate how changing the shape of the first and second edges of each notch, and the angle at which the edges meet each other within the notch may be used to provide greater control over the shape of the airbag, for any particular application.

In preferred embodiments of the invention the angle where each first and second edge of each notch meets the top or bottom edge (as appropriate) of the blank is exactly or substantially 90°. This is the angle at each termination point 14. This leads to a relatively smooth line where the first and second edges 16, 17 of the notch are joined to each other, and will also reduce the risk of leakage.

In this specification, where it is stated that a lateral seam meets a main seam, this should be understood as the lateral seam meeting the main seam at a location partway along the length of the main seam, such that the main seam extends in both directions from the point at which the lateral seam meets the main seam.

Preferably a lateral seam serves no function of joining two or more different panels of an air-bag together, and is a connection between two edges of the same panel.

References in this document to a seam having a free end refer to the seam terminating in such a way that the free end of the seam is substantially surrounded by the fabric of one or more panels of the air-bag, without the seam continuing on past the free end, or connecting to or aligning with another seam at the free end.

When constructing an air-bag, it is often advantageous to perform sewing operations, to join panels of the air-bag together, and then to turn the air-bag inside out before it is prepared for use. This means that protruding sewn edges are positioned on the interior surface of the air-bag (rather then the exterior), and are less likely to cause injury or discomfort to a vehicle occupant during deployment.

With reference to the known air-bag 1 shown in FIG. 1, the skilled reader will appreciate that it is difficult to turn the air-bag inside out in this way, because the construction primarily involves a single sewing operation, which is sewing the side panels 2, 3 together at the main seam 4. Once this has been done there is no way to turn the air-bag 1 inside out.

However, in construction of an air-bag using (for example, the first blank 6 shown in FIG. 2, the top and bottom edges 10, 11 of the side panels 7, 8 can be joined together, and the first and second edges 16, 17 of a first one of the notches 15 can be joined together. After this, the air-bag can be turned inside out, by being pushed through the gap between the first and second edges 16, 17 of the second one of the notches 15. Finally, the first and second edges 16, 17 of the second one of the notches 15 can be joined together. The result is that all seams, aside from the one between the first and second edges 16, 17 of the second one of the notches 15, are on the interior side of the finished air-bag.

The invention therefore provides a method of constructing an air-bag from a blank as disclosed herein, comprising the steps of joining the first and second side panels together, and then turning the air-bag inside out by passing all or part of the blank through the gap between the first and second edges of a notch, and then joining the edges of the notch together.

In the discussion above, air-bags embodying the invention are positioned to inflate between a vehicle occupant and an interior side wall of a vehicle. However, the invention is not limited to this. In other implementations, an air-bag embodying the invention may be positioned to inflate between the driver and passenger seats of a vehicle (such an air-bag is known as a “far side” air-bag). A far side air-bag helps to prevent a seat occupant from being flung by an impact across the gap between the seats, and is preferably a robust and relatively thick air-bag. The skilled reader will understand how the techniques above, of using lateral seam(s) to control the shape and thickness of the air-bag, will be useful in constructing an effective air-bag of this type.

Air-bags embodying the invention may be used in still further locations within or outside a vehicle of any kind.

In use, the air-bag will be rolled and/or folded, and positioned within a housing, as is known in the art. The housing may have one or more lines or regions which are adapted to break when the air-bag is inflated, so that during deployment the air-bag emerges from the housing in a desired manner. The air-bag may be mounted in a vehicle seat, and more particularly in a side region of the seat. However, this is not essential.

When installed in a vehicle the air-bag will be connected to an inflator, which is adapted to provide pressurised gas to an interior of the air-bag, to inflate the air-bag during deployment. The inflator may be of any known type, such as a pyrotechnic inflator or an inflator which has a supply of compressed gas. In FIGS. 2 and 5 an inflation aperture 54 is shown, which in use will allow the ingress of air into the air-bag for inflation. In the examples shown in the figures the inflation aperture 54 is provided in the connection region 9, but this is not essential and one or more inflation apertures may be provided in any suitable locations.

The skilled reader will appreciate that airbag formed in accordance with the invention may confer significant advantages with respect to known types of airbag, and will provide additional protection to vehicle occupants.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. An air-bag, comprising opposing first and second side panels, which are joined together at a main seam, wherein:
a first lateral seam meets the main seam and extends away therefrom, terminating at a free end, wherein the first lateral seam is formed from opposing edges formed in the first side panel, which are joined to each other.

2. The air-bag according to claim 1, further comprising a second lateral seam which meets the main seam, the second lateral seam extending away from the main seam on an opposite side thereof from the first lateral seam, and terminating in a free end, wherein the second lateral seam is formed from opposing edges formed in the second side panel, which are joined to each other.

3. The air-bag according to claim 2, wherein the second lateral seam meets the main seam at or near the location where the first lateral seam meets the main seam.

4. The air-bag according to claim 1, wherein the first lateral seam is positioned at or near a junction between a top surface of the air-bag and a front surface of the air-bag.

5. The air-bag according to claim 1, wherein the first lateral seam is positioned at or near a junction between a bottom surface of the air-bag and a front surface of the air-bag.

6. The air-bag according to claim 1, further comprising a third lateral seam, which meets the main seam at a location which is spaced apart from the location at which the first lateral seam meets the main seam, the third lateral seam terminating at a free end and being formed from opposing edges formed in the first or second side panel, which are joined to each other.

7. The air-bag according to claim 6, further comprising a fourth lateral seam, which meets the main seam at a location which is at or near the location at which the third lateral seam meets the main seam, the fourth lateral seam terminating at a free end and being formed from opposing edges formed in the other one of the first or second side panel, which are joined to each other.

8. The air-bag according to claim 1, wherein the or each lateral seam is formed from a notch formed in an edge of the first or second side panel, wherein the notch has the opposing edges which are joined to each other.

9. The air-bag according to claim 8, wherein the opposing edges of the notch are straight or substantially straight and meet each other at an angle at a meeting point.

10. An air-bag module comprising an air-bag comprising opposing first and second side panels, which are joined together at a main seam, wherein; a first lateral seam meets the main seam and extends away therefrom terminating at a free end, wherein the first lateral seam is formed from opposing edges formed in the first side bed to each other, the air-bag being provided within a housing.

11. An air-bag comprising opposing first and second side panels, which are joined together at a main seam, wherein a first lateral seam meets the main seam and extends away therefrom, terminating at a free end, wherein the first lateral seam is formed from opposing edges formed in the first side panel, which are joined to each other, and the air-bag further comprises:
a third lateral seam, which meets the main seam at a location which is spaced apart from the location at which the first lateral seam meets the main seam, the third lateral seam terminating at a free end and being formed from opposing edges formed in the first or second side panel, which are joined to each other; and
a fourth lateral seam, which meets the main seam at a location which is at or near the location at which the third lateral seam meets the main seam, the fourth lateral seam terminating at a free end and being formed from opposing edges formed in the other one of the first or second side panel, which are joined to each other.
